(19) United States
(12) Patent Application Publication
(10) Pub. No.: US 2015/0004872 A1
(43) Pub. Date: Jan. 1, 2015

(54) Device with Detachable Secure Holder for Pacifier

(71) Applicant: Raquel Lynn Taylor, Erie, PA (US)

(72) Inventor: Raquel Lynn Taylor, Erie, PA (US)

(21) Appl. No.: 13/930,336

(22) Filed: Jun. 28, 2013

(51) Int. Cl. A61J 17/00; A63H 3/02

(52) U.S. Cl. CPC A61J 17/00; A63H 3/02; A61J 2017/007
USPC 446/227

(57) ABSTRACT

What is presented is a device that is aesthetically attractive to juveniles of all ages. The device comprises a flexible fabric body, which is shaped to not block the nasal passages of a juvenile when using the device. The body has a first end and a second end. The first end has a detachable secure holder that releasably fastens to the body, creating an attachment site at the first end. The detachable secure holder is also adapted to attach a pacifier to the body.

### BACKGROUND

During the night or while napping, juveniles, especially newborns, infants, and toddlers, are often sent to sleep with a pacifier in their mouth for comfort while they sleep. Many juveniles also use pacifiers, which act as a soother, during waking periods as well. Often these pacifiers fall out of the juvenile's mouth and get lost, causing the juvenile to wake up in discomfort. Discomfort of this nature will ultimately cause the juvenile to cry out for an adult, to assist in returning the pacifier to their mouth, which is a hassle for the adult who has to get up and walk over to the juvenile, comfort the juvenile, and assist in returning the pacifier to the juvenile's mouth. Also, if ever lost, this device is easier for adults to locate than a single pacifier by itself. What is presented is an aesthetically pleasing and attractive stuffed device that detachably secures to a pacifier so a juvenile can more easily locate, pick up, and properly return the pacifier into their mouth without assistance from an adult.

### SUMMARY

What is presented is a device that is aesthetically attractive to juveniles of all ages. The device comprises a flexible fabric body, which is shaped to not block the nasal passages of a juvenile when they are using the device. The body has a first end and a second end. The first end has a detachable secure holder that releasably fastens to the body, creating an attachment site at the first end. The detachable secure holder is also adapted to attach a pacifier to the body.

The body could have an elongated shape. The maximum length of the body could be 6 inches and the maximum width of the body could be 3 inches. The body could comprise a plurality of segments. The body could be multi-colored or shaped like a stuffed animal or both. The stuffed animal shape could be a caterpillar, lion, bee, monkey, giraffe, owl, or elephant. The body could also be shaped to promote the development of gross motor skills in the juvenile.

The detachable secure holder could comprise industrial strength hook and loop fastener. The combined weight of the device and pacifier could be less than an ounce. The combined weight of the device and pacifier is low enough to avoid damage to the teeth of the juvenile. The device could be machine washable.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1A is a side view of the front side of the stuffed device;

FIG. 1B is a side view of the back side of the stuffed device;

FIG. 2A is a side view of the front side of the of the stuffed device of FIG. 1A with a pacifier detachably secured to it;

FIG. 2B is a side view of the back side of the of the stuffed device of FIG. 1A with a pacifier detachably secured to it; and

FIG. 3 is a side view of the front side of another embodiment of the stuffed device with a pacifier detachably secured to it.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

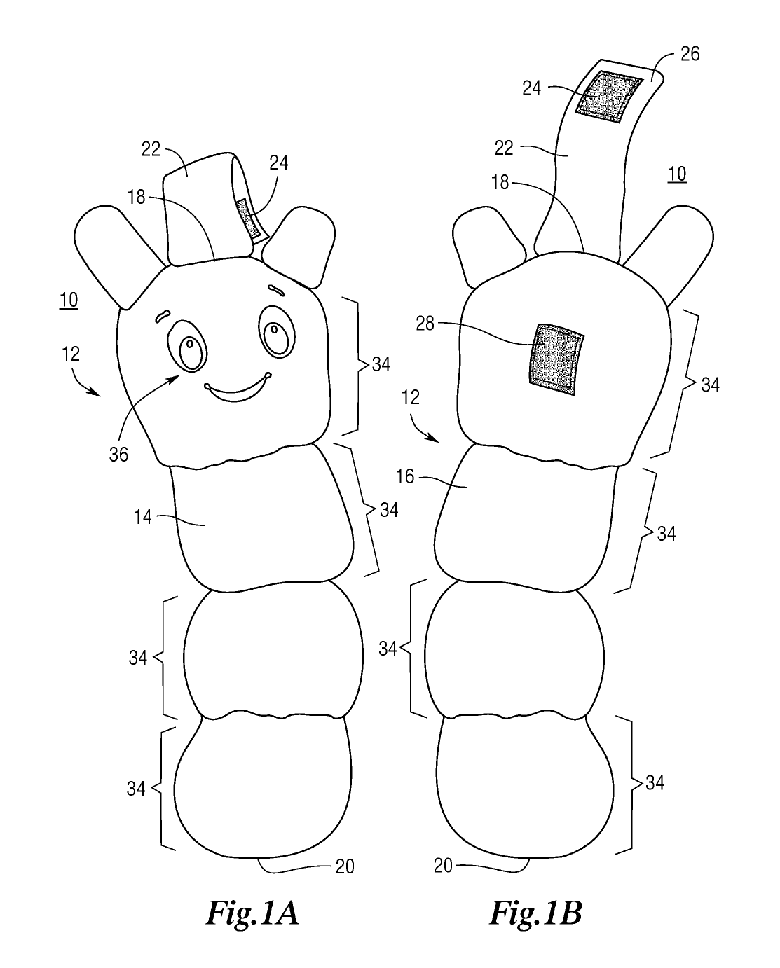

As shown in FIGS. 1A and 1B, a stuffed device 10 for juveniles of all ages can be seen. The stuffed device 10 has a flexible elongated body 12 with a front side 14, back side 16, first end 18 and a second end 20. The first end 18 of the elongated body 12 comprises a detachable secure holder 22 permanently affixed to it. This detachable secure holder 22 is foldable to cover the first end 18 of the elongated body 12 to attach a pacifier (as discussed herein) at the first end 18 of the elongated body 12.

The detachable secure holder 22 comprises a cut out square shaped portion of industrial strength hook and loop fastener, such as VELCRO, which is the first portion 24, joined to the far end 26 of the detachable secure holder 22. The far end 26 is the end of the detachable secure holder 22 flap situated farthest away from the elongated body 12. This first portion 24 of industrial strength hook and loop fastener releasably fastens to the elongated body 12 by mating with a similarly shaped cut out portion of industrial strength hook and loop fastener, which is the second portion 28. Industrial strength hook and loop fastener is used because it is strong enough to prevent juvenile's from pulling the first portion 24 apart from the second portion 28. It should be understood that the first portion 24 and second portion 28 of industrial strength hook and loop fastener does not have to be cut into a square shape. Other shapes, such as, but not limited to, circular, triangular, and rectangular, may work.

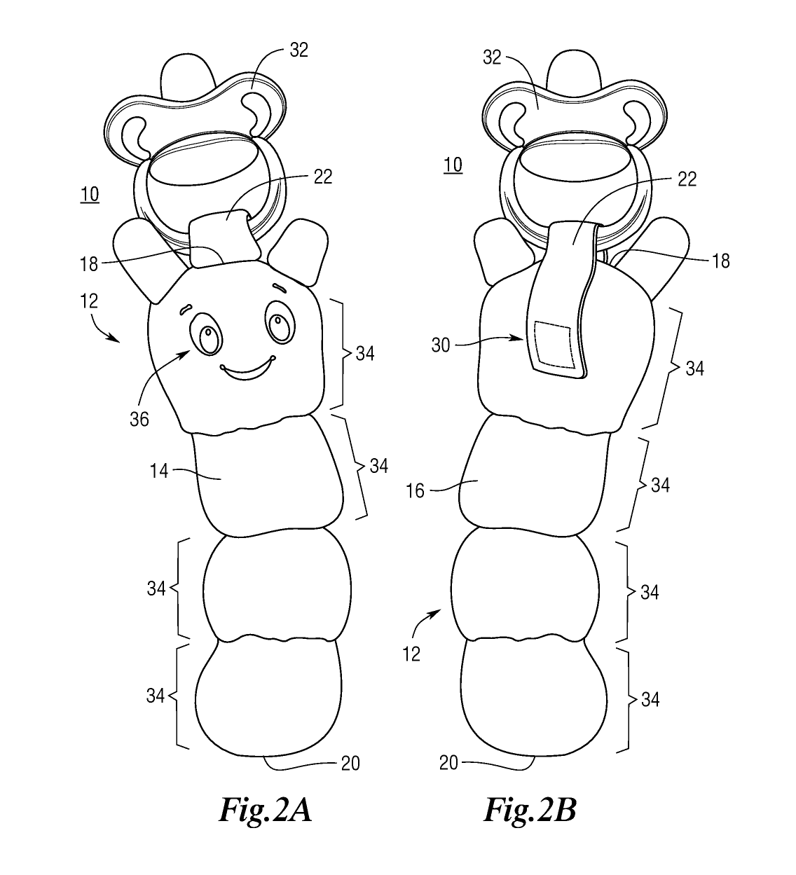

As shown in FIGS. 2A and 2B, when both the first portion 24 and second portion 28 of industrial strength hook and loop fastener are mated, an attachment site 30 is created. The attachment site 30 is located specifically on the back side of the elongated body 12, near the first end 18, adapting the detachable secure holder 22 to attach a pacifier 32 at the first end 18 of the elongated body 12. When properly attached, the pacifier 32 is pressed snug against the first end 18 of the elongated body 12 and the pacifier's 32 nipple faces away from the front side 14 of the elongated body 12. The juvenile's mouth should face the front side 14 of the elongated body 12 when using the stuffed device 10.

Positioning the attachment site 30 at this location ensures the stuffed device 10 hangs below the juvenile's mouth, and the stuffed device 10 in no way covers the juvenile's face, when sucking on the pacifier 32. With the stuffed device 10 hanging below the juvenile's mouth, the risk of suffocating the juvenile is reduced. Positioning the attachment site 30 at this location also keeps the attachment site 30 hidden from the juvenile's view and gives the appearance that the pacifier 32 is permanently affixed to the stuffed device 10, when the juvenile is sucking on the pacifier 32. This orientation helps to keep the juvenile from being tempted to separate the pacifier 32 from the stuffed device 10.

Industrial strength hook and loop fastener is used in the manufacture of the stuffed device 10 because this variety of hook and loop fastener is generally much stronger than varieties of lesser quality, ensuring only an adult, not the juvenile, has the strength to separate the pacifier 32 from rest of the stuffed device 10 when detachably secured together. Industrial strength hook and loop fastener is also waterproof, any of the juvenile's saliva coming into contact with the first portion 24 and second portion 28 of the industrial strength hook and loop fastener will not affect their mating and cause the pacifier 32 to prematurely detach from the stuffed device 10. Since industrial strength hook and loop fastener is waterproof, it should be understood there will not be any damage or loss of strength to either portion 24 or 28 of the industrial strength hook and loop fastener when being machine washed.

Both the stuffed device 10 and pacifier 32 have a combined weight of less than an ounce when detachably secured together. This combined weight is minimal, allowing the juvenile to properly hold the stuffed device 10 up while sucking on the pacifier 32. Holding the stuffed device 10 up properly keeps the pacifier 32 from dragging down on the juvenile's mouth, which can have negative effects on a juvenile's teeth. The combined weight is low enough to avoid damages to the teeth of the juvenile.

The elongated body 12 has a generally tubular shape with a maximum length that is at most six inches long and a maximum width that is at most three inches wide. The elongated body 12 is large enough for the juvenile to snuggle with and provide additional comfort while sucking on the pacifier 32 during use of the stuffed device 10. The shape of the elongated body 12 allows a juvenile to properly grip it and control the pacifier 32. As discussed in more detail above, the shape of the elongated body 12 and its position during use keeps the juvenile's nasal passages from being blocked, which can suffocate the juvenile while sucking on the pacifier 32. One having ordinary skill in the art will see that the body 12 does not have to be elongated. Other shapes of the body may work, such as, but not limited to, circular, square, ovular, and triangular.

In this embodiment, the elongated body 12 is divided into four ball shaped segments 34. These segments help promote the development of gross motor skills in the juvenile when they are moving the stuffed device 10 around with their hands. The segments also help the juvenile to learn their way around the stuffed device 10 and help them locate the attached pacifier 32 with their mouth by giving a sense of orientation when holding the elongated body 12 below their line of sight. This helps reduce the need for an adult help retrieve and put the pacifier 32 into the juvenile's mouth. Each segment has its own color, so that the entire elongated body 12 is multi-colored. The multi-colored elongated body 12 also makes it easier for the juvenile or an adult to find than a single pacifier by itself, if the juvenile drops and loses the stuffed device 10.

In the embodiment as shown, the stuffed device 10 has a stuffed animal shape that is a caterpillar, which comprises pleasing facial features 36 projecting the feelings of joy. However, it should be understood the stuffed device 10 could have a different stuffed animal shape, could comprise different facial features 36, or could comprise no facial features 36 whatsoever. Such stuffed animal shapes include, but are not limited to, a lion, bee, monkey, giraffe, owl, or elephant. The multi-coloring, stuffed animal shape of the elongated body 12, and facial features 36 make the stuffed device 10 aesthetically pleasing and attractive to juveniles of all ages. Being aesthetically pleasing and attractive encourages the juvenile to pick up and properly use the stuffed device 10 without the need for additional promotion from an adult.

The fabric used in the manufacture of the stuffed device 10 is typically made from threads that are 50% acrylic material and 50% non-acrylic material, such as, but not limited to, cotton or wool. The stuffing (not shown) filling the elongated body 12 is manufactured from polyester fibers. This combination of fabric and stuffing allows the stuffed device 10 to be machine washed without shrinking or warping any components that the stuffed device 10 comprises. The ability to machine wash the stuffed device 10 ensures that it can be thoroughly cleaned between every use, helping to reduce the spreading of germs and disease. One having ordinary skill in the art will see that any fabric or stuffing able to be machine washed without shrinking or warping the stuffed device 10 may work.

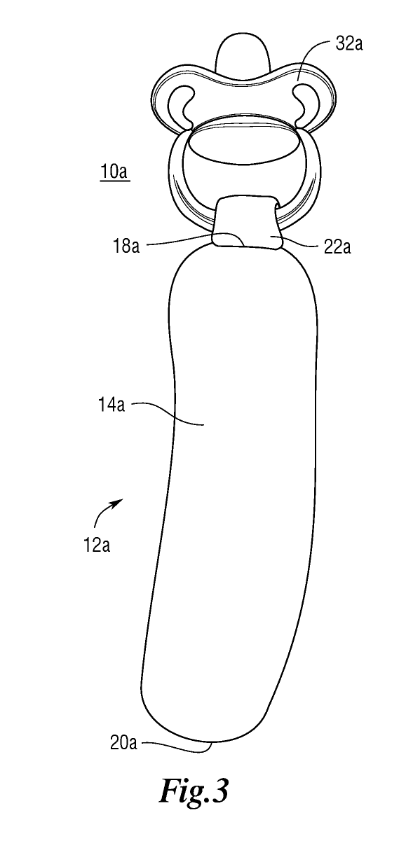

As shown in FIG. 3, another embodiment of the stuffed device 10a can be seen. This embodiment is the same as the previous embodiment discussed above, except that it is not as aesthetically pleasing and attractive. Here, the stuffed device 10a has a flexible elongated body 12a with a front side 14a, back side (not shown), first end 18a and a second end 20a. The first end 18a of the elongated body 12a comprises a detachable secure holder 22a permanently affixed to it. This detachable secure holder 22a functions to attach a pacifier 32a to the elongated body 12a of the stuffed device 10a.

The elongated body 12a in this embodiment has no segments and is not multi-colored. Moreover, there are no facial features and the shape of the elongated body 12a is substantially cylindrical. However, it should be understood that the stuffed device 10a could have a different elongated shape, such as, but not limited to, rectangular or triangular. Not being as aesthetically pleasing and attractive as the previous embodiment discussed above, one having ordinary skill in the art should see that additional encouragement from an adult may be needed for the juvenile to pick up and use this embodiment of the stuffed device 10a properly.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

1. A device that is aesthetically attractive to juveniles of all ages comprising:
a flexible fabric body having a first end and a second end;
said first end having a detachable secure holder;
said detachable secure holder releasably fastens to said body, creating an attachment site at said first end of said body;
said detachable secure holder is adapted to attach a pacifier to said body; and
said body is shaped not to block the nasal passages of a juvenile when in use.

2. The device of claim 1 wherein said detachable secure holder comprises industrial strength VELCRO.

3. The device of claim 1 wherein said body has an elongated shape.

4. The device of claim 1 wherein the maximum length of the body is 6 inches and the maximum width of the body is 3 inches.

5. The device of claim 1 wherein the combined weight of said device and the pacifier is less than an ounce.

6. The device of claim 1 wherein the combined weight of said device and the pacifier is low enough to avoid damage to the teeth of the juvenile.

7. The device of claim 1 wherein said device is machine washable.

8. The device of claim 1 wherein said body comprises a plurality of segments.

9. The device of claim 1 wherein said body is multi-colored.

10. The device of claim 1 wherein said body is a stuffed animal.

11. The device of claim 1 wherein said body is shaped to promote the development of gross motor skills in the juvenile.

12. The device of claim 1 wherein said body is a stuffed animal shaped like a caterpillar.

13. The device of claim 1 wherein said body is a stuffed animal shaped like a lion.

14. The device of claim 1 wherein said body is a stuffed animal shaped like a bee.

15. The device of claim 1 wherein said body is a stuffed animal shaped like an owl.

16. The device of claim 1 wherein said body is a stuffed animal shaped like a monkey.

17. The device of claim 1 wherein said body is a stuffed animal shaped like a giraffe.

18. The device of claim 1 wherein said body is a stuffed animal shaped like an elephant.

19. The device of claim 1 wherein said flexible fabric is 50% acrylic and 50% non-acrylic.

20. A machine washable stuffed animal shaped device that is aesthetically attractive to juveniles of all ages comprising:
a flexible fabric body having a first end and a second end;
said first end having a detachable secure holder;
said detachable secure holder comprises industrial strength VELCRO and releasably fastens to said body, creating an attachment site at said first end of said body;
said detachable secure holder is adapted to attach a pacifier to said body;
said stuffed animal and pacifier have a combined weight of less than an ounce; and
said body is shaped not to block the nasal passages of a juvenile when in use.
